(19) United States
(12) Patent Application Publication
(10) Pub. No.: US 2013/0199044 A1
(43) Pub. Date: Aug. 8, 2013

(54) Method of Forming a Sprocket

(71) Applicant: Yahya Hodjat, Oxford, MI (US)

(72) Inventor: Yahya Hodjat, Oxford, MI (US)

(21) Appl. No.: 13/364,424

(22) Filed: Feb. 2, 2012

(51) Int. Cl. B23P 15/14; B21D 53/28

(52) U.S. Cl. 29/893.3

(57) ABSTRACT

A method of forming a sprocket comprising forming a circular blank having a plane, cutting a plurality of radially extending slots about the outer circumference of the blank thereby forming a plurality of adjacent tabs, bending the tabs 90 degrees to the blank plane, and forming each tab into a tooth form with a groove disposed between adjacent teeth.

### FIELD OF THE INVENTION

The invention relates to a method of forming a sprocket comprising forming a circular blank having a plane, cutting a plurality of radially extending slots about the outer circumference of the blank thereby forming a plurality of adjacent tabs, bending the tabs 90 degrees to the blank plane, and forming each tab into a tooth form with a groove disposed between adjacent teeth.

### BACKGROUND OF THE INVENTION

Sprockets are a necessary part of power transmission via timing belts, also known as cog belts. There are many methods of manufacturing sprockets such as cast iron and machined, die cast aluminum, spun, or press formed. For high wear metals such as aluminum, there is also the need for a flame or plasma deposited hard coating. All of these processes and some other known processes produce good sprockets, but, the cost is high. For instance, a motor cycle wheel drive sprocket costs anywhere between $20 to $40 depending on size, shape and volume of production. Most of these processes also require a very high tooling investment.

Representative of the art is U.S. Pat. No. 6,672,126 which discloses a cam die. The cam die comprises at least one cam ring. The cam ring comprises a plurality of moveable cam teeth. The cam teeth are moveable on a normal toward an axis of the cam die by a cam actuator. The cam actuator has an inside diameter that is less than an outside diameter of the cam ring. As the cam actuator moves parallel to the cam die axis along an outside circumference of the cam ring, the cam teeth are progressively engaged and pressed inwardly toward a work piece. The work piece is moved simultaneously with the cam actuator by action of a punch that is concentric with the cam actuator and within the diameter of the cam ring. Each cam tooth is simultaneously engaged with the work piece as the work piece passes. A resilient member returns each cam tooth to a starting position after the cam actuator is withdrawn, allowing ejection of a finished part.

What is needed is a method of forming a sprocket comprising forming a circular blank having a plane, cutting a plurality of radially extending slots about the outer circumference of the blank thereby forming a plurality of adjacent tabs, bending the tabs 90 degrees to the blank plane, and forming each tab into a tooth form with a groove disposed between adjacent teeth. The present invention meets this need.

### SUMMARY OF THE INVENTION

The primary aspect of the invention is a method of forming a sprocket comprising forming a circular blank having a plane, cutting a plurality of radially extending slots about the outer circumference of the blank thereby forming a plurality of adjacent tabs, bending the tabs 90 degrees to the blank plane, and forming each tab into a tooth form with a groove disposed between adjacent teeth.

Other aspects of the invention will be pointed out or made obvious by the following description of the invention and the accompanying drawings.

The invention comprises a method of forming a sprocket comprising forming a circular blank having a plane, cutting a plurality of radially extending slots about the outer circumference of the blank thereby forming a plurality of adjacent tabs, bending the tabs 90 degrees to the blank plane, and forming each tab into a tooth form with a groove disposed between adjacent teeth.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a perspective view of the sprocket blank.

FIG. 2 is a perspective view of the partially formed sprocket blank.

FIG. 3 is a perspective view of the partially formed sprocket blank.

FIG. 4 is a perspective view of the fully formed sprocket.

FIG. 5 is a perspective view of the first die, second die and the fully formed sprocket.

FIG. 6 is a perspective view of the first die, second die and the fully formed sprocket.

FIG. 7 is a perspective view of the first die and second die in operational relation to the fully formed sprocket.

FIG. 8 is a perspective view of the first die in operational relation to the sprocket.

FIG. 9 is a composite perspective showing the forming sequence.

### DETAILED DESCRIPTION OF THE PREFERRED EMBODIMENT

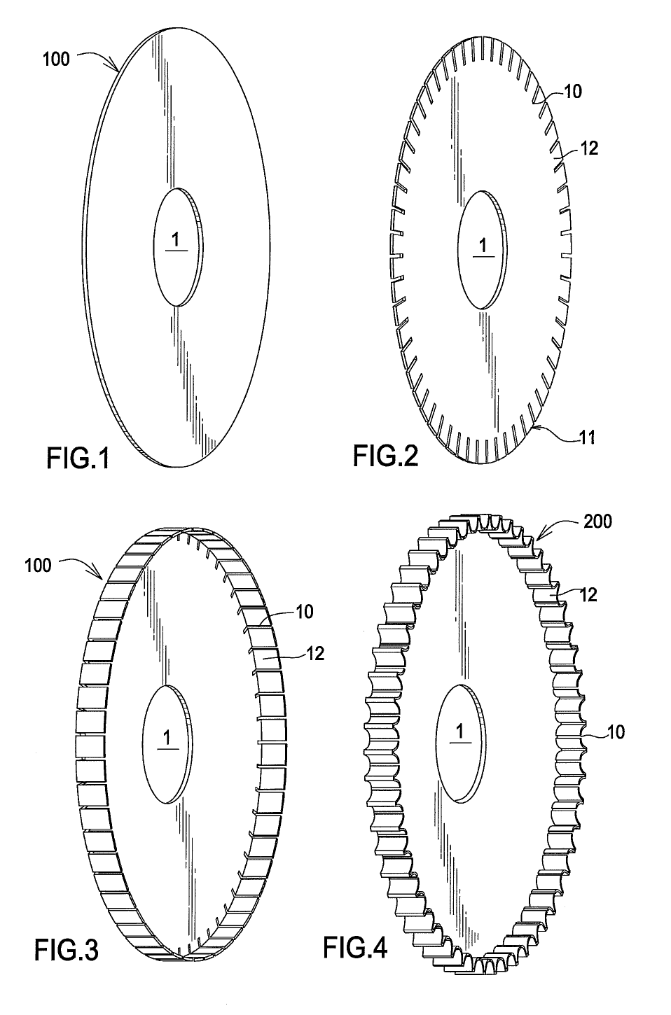

FIG. 1 is a perspective view of the sprocket blank. In the first step, a blank 100 is stamped from a piece of sheet metal. Blank 100 is typically round. A hole 1 may also be stamped or cut in the blank 100.

FIG. 2 is a perspective view of the partially formed sprocket blank. In the second step, a plurality of radially extending slots 10 is cut into the outer edge 11 of the blank 100. The slots are equally spaced as required by the user. Cutting the slots forms a plurality of adjacent tabs 12. The spacing between each adjacent slots 10 is predetermined to accommodate the size of the selected sprocket grooves that will be formed by the inventive process.

FIG. 3 is a perspective view of the partially formed sprocket blank. In this next step, tabs 12 are bent 90 degrees to the plane of the blank. The bend is aligned with approximately 75% of the depth of the slots 10. Extending each slot beyond the bend in this manner prevents tearing of the material during formation of the groove and tooth. All of the tabs 12 about the entire perimeter of the blank are bent in the same direction.

FIG. 4 is a perspective view of the fully formed sprocket. In this next step, sprocket teeth are formed from each tab 12. Each tab 12 extends between each adjacent groove. Each slot 10 is disposed between each tooth/tab 12 at the base of each adjacent groove. Each slot 10 at the base of each groove does not affect performance of the sprocket. Instead, each slot 10 allows debris to escape from the affected groove, thereby eliminating the undesirable effects of dirt and debris that may otherwise be trapped between the belt tooth and the groove. Trapped debris can result in tooth skipping (ratcheting) or accelerated wear of the belt.

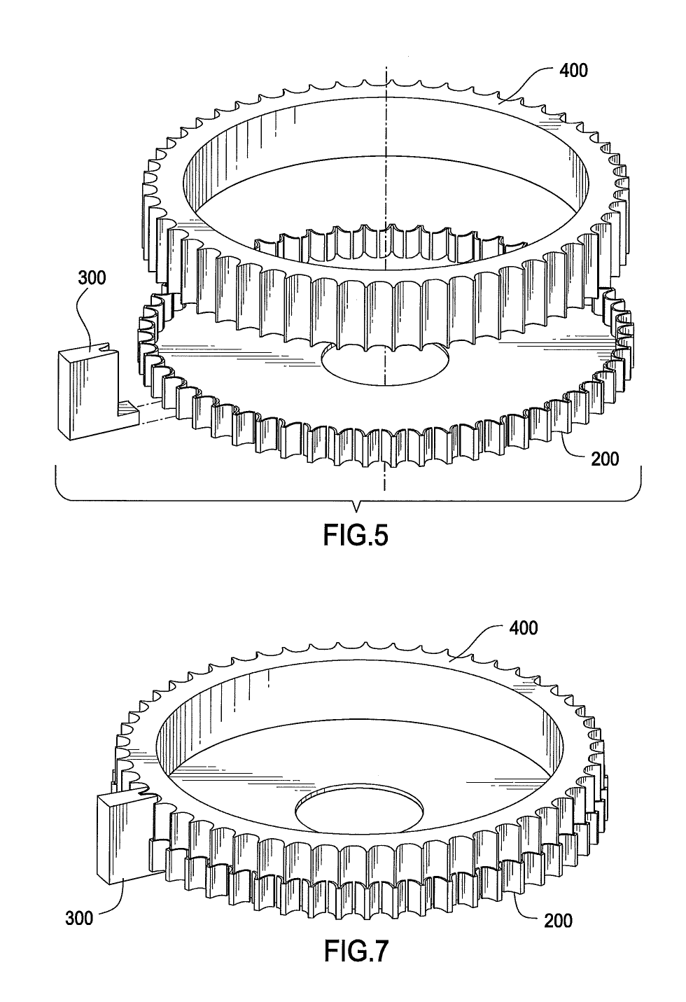

FIG. 5 is a perspective view of the first die, second die and the fully formed sprocket. The first die 300 engages the second die 400 to form each tooth in the finished sprocket 200. During forming first die 300 engages a tab 12, pressing radially inward toward the cooperating second die 400. The surface of second die 400 comprises grooves and teeth which correspond to the groove and teeth to be formed in the sprocket. First die 300 comprises a concave recess which cooperatively engages a tooth form 401 on the second die as shown in FIG. 7.

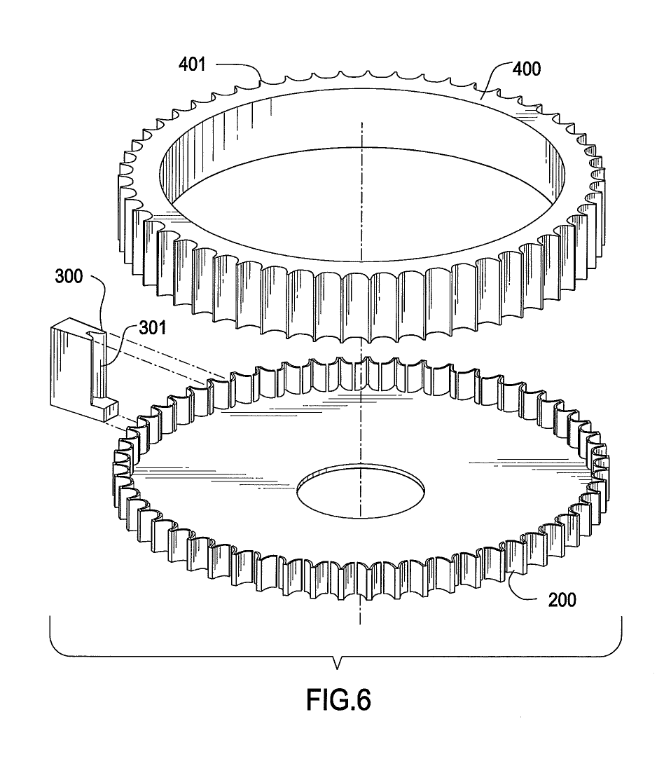

FIG. 6 is a perspective view of the first die, second die and the fully formed sprocket.

FIG. 7 is a perspective view of the first die and second die in operational relation to the fully formed sprocket. The first die 300 is shown engaged with the second die 400 and with the formed sprocket 200 there between. The tooth forming step may occur sequentially, that is one tooth at a time such as when the die are rolling, or simultaneously.

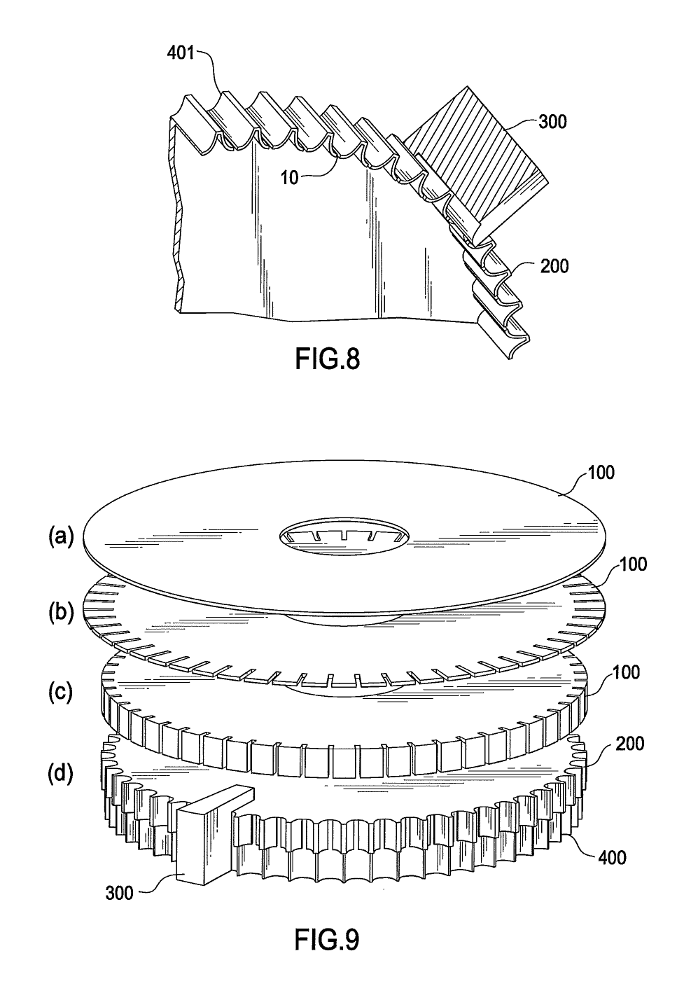

FIG. 8 is a perspective view of the first die in operational relation to the sprocket. First die 300 is shown in a half section to depict its relation to a second die tooth 401.

FIG. 9 is a composite perspective showing the forming sequence.

Although a form of the invention has been described herein, it will be obvious to those skilled in the art that variations may be made in the construction and relation of parts without departing from the spirit and scope of the invention described herein.

I claim:

1. A method of forming a sprocket comprising:
forming a circular blank having a plane;
cutting a plurality of radially extending slots about the outer circumference of the blank thereby forming a plurality of adjacent tabs;
bending the tabs 90 degrees to the blank plane;
forming each tab into a tooth form with a groove disposed between adjacent teeth.

2. The method as in claim 1 comprising forming a central hole in the blank.

3. The method as in claim 1, wherein a slot is disposed in the bottom of each groove.
